(19) United States
(12) Patent Application Publication
(10) Pub. No.: US 2025/0298892 A1
(43) Pub. Date: Sep. 25, 2025

(54) MALICIOUS ENCRYPTION DETECTION BASED ON BYTE FREQUENCY DISTRIBUTION

(71) Applicant: NetApp, Inc., San Jose, CA (US)

(72) Inventors: Muneem Shahriar, San Jose, CA (US); Mesfin Dema, San Jose, CA (US); Arunkumar Gururajan, San Jose, CA (US); Jian Jian, San Jose, CA (US)

(21) Appl. No.: 18/613,966

(22) Filed: Mar. 22, 2024

(51) Int. Cl. G06F 21/55; G06F 21/56

(52) U.S. Cl. CPC G06F 21/554; G06F 21/566; G06F 21/568

(57) ABSTRACT

Systems, methods, and software are disclosed herein for detecting encrypted data in various implementations. In an implementation, a computing apparatus determines byte frequency distribution values associated with a compute workload. The computing apparatus executes a machine learning model trained to differentiate between encrypted portions and non-encrypted portions of the compute workload based on the byte frequency distribution values. The computing apparatus monitors an encrypted share of the compute workload represented by the encrypted portions and, in response to the encrypted share meeting or exceeding a threshold, initiating a mitigative action.

### TECHNICAL FIELD

Aspects of the disclosure are related to the field of computer software security and ransomware detection.

### BACKGROUND

Ransomware attacks are a form of malware or “malicious software” that involves the infiltration of secure data storage by malicious actors who encrypt the data and demand payment for the data to be released. During a ransomware attack, encryption algorithms transform the data into a ciphertext which appears random and unintelligible. The transformation is highly complex and non-linear and therefore nearly impossible to reverse-engineer. Thus, to reacquire the original information from the ciphertext requires a decryption key.

Ransomware often infiltrates systems through phishing emails, malicious websites, or other software vulnerabilities. Modern ransomware strains may employ techniques to evade detection, such as changing their code signatures or disabling security measures. Once the ransomware has encrypted files or established control over the system, it surfaces a message demanding payment in exchange to restore access. However, what makes ransomware attacks particularly insidious is that when ransomware attacks first infiltrate a system, they are often designed to execute undetected for a period of time prior to surfacing so that when the system backs up its data, the backup data is also infected and cannot be used to restore the data to an uninfected state. Given the potential for devastating data loss, protection against ransomware infiltration typically involves early detection to limit the extent of the infiltration and to preserve an uninfected, restorable state of the system.

### OVERVIEW

Systems, method, and software are disclosed herein for detecting encrypted data in various implementations. In an implementation, a computing apparatus determines byte frequency distribution values associated with a compute workload. The computing apparatus executes a machine learning model trained to differentiate between encrypted portions and non-encrypted portions of the compute workload based on the byte frequency distribution values. The computing apparatus monitors an encrypted share of the compute workload represented by the encrypted portions and, in response to the encrypted share meeting or exceeding a threshold, initiates mitigative action.

In an implementation, to determine the byte frequency distribution values associated with a compute workload, the computing apparatus identifies blocks of the compute workload and computes a byte frequency distribution value for each of the identified blocks. In an implementation, the computing apparatus encodes the byte frequency distribution values into feature vectors and supplies the feature vectors as input to the machine learning model. To encode the byte frequency distribution values into the feature vectors, in an implementation, the computing apparatus identifies block groupings within the identified blocks, with the groupings comprising three or more blocks. For each of the block groupings, the computing apparatus encodes byte frequency distribution values for each of the blocks into a single feature vector. In an implementation, the compute workload includes a virtual machine disk (VMDK) file and the identified blocks of the compute workload included changed blocks of the VMDK file.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for encryption detection in an implementation.

FIG. 2 illustrates a process for encryption detection in an implementation.

FIG. 3 illustrates an operational architecture for encryption detection in an implementation.

FIG. 4 illustrates a workflow for encryption detection in an implementation.

FIG. 5 illustrates an operational scenario for generating byte frequency distributions for encryption detection in an implementation.

FIG. 6 illustrates examples of byte frequency distributions generated for encryption detection in an implementation.

FIG. 7 illustrates methods of training a machine learning model for encryption detection in an implementation.

FIG. 8 illustrates a machine learning architecture for encryption detection in an implementation.

FIG. 9 illustrates a computing system suitable for implementing the various operational environments, architectures, processes, scenarios, and sequences discussed below with respect to the other Figures.

### DETAILED DESCRIPTION

To maintain the security of data systems, such systems often employ methods for detecting ransomware attacks. Data encryption in a ransomware attack involves converting data into a code using a sophisticated encryption algorithm, such as AES (Advanced Encryption Standard) or RSA (Rivest-Shamir-Adleman). The encryption algorithm transforms the data into a ciphertext which appears random and unintelligible, thus disabling the infected system. To detect a ransomware attack, a data system may use an entropy-based method which involves calculating an entropy of the stored data files and which may indicate signs of infiltration. Encrypted data typically displays a high level of entropy, and entropy-based methods quantify noise or randomness in the data.

However, entropy-based methods of ransomware detection suffer from over- as well as under-detection for a number of reasons. At the early stages of a ransomware attack, encryption levels may be so low as to be undetectable in an entropy calculation. In addition, when a data file is compressed, it typically displays entropy levels similar to those of encrypted files. Moreover, encryption is commonly used for data security, such as for secure data transmission, and entropy calculations do not differentiate legitimate encryption from malicious encryption. As such, determining a threshold level of entropy which indicates a ransomware attack must balance legitimate encryption and encryption-like file characteristics with being sensitive to actual malicious activity. In practice, however, the threshold is often set too high to be sensitive to an attack in its earliest stages. Inevitably, the use of entropy to detect ransomware will result in false positive and false negative errors which in turn result in unnecessary processing overhead or, worse, leaving the data unprotected from a ransomware attack.

Systems, methods, and devices are disclosed herein for detecting malicious encryption of data (e.g., a ransomware attack on the data) based on identifying samples from the data which are encrypted. To identify whether a sample of data is encrypted, a trained machine learning model is used to classify a byte frequency distribution of the sample data as encrypted or non-encrypted. In an implementation, a system for detecting malicious encryption of data receives samples of data from a data source and generates byte frequency distributions for the samples. The byte frequency distributions are supplied in the form of feature vectors to a machine learning model which is trained to differentiate encrypted samples of the data from non-encrypted samples of the data. As the samples are classified as “encrypted” or “non-encrypted” by the model, the system monitors the percentage or share of the source data which is classified as encrypted based on the sample classifications. When the share of encrypted data meets or exceeds a threshold value, the system determines that the data is being maliciously encrypted and initiates mitigative action to stem the attack.

In an implementation of the technology disclosed herein, a virtual machine created from a Virtual Machine Disk (VMDK) file executes on a computing device. In an exemplary scenario, a virtual machine of a VMDK file may be hosted by a hypervisor platform executing on a server computing device. As workload operations or processes occur within the virtual machine, blocks of data are written to the VMDK file. As the virtual machine operates, copies of the VMDK file are generated at regular intervals in the form of image files or snapshots of the VMDK file. The VMDK snapshots may be delta files which include blocks of data that have been recently modified, that is to say, that have been modified since a previous snapshot was taken or since a baseline VMDK file was generated. To detect a malicious infiltration (e.g., ransomware encryption) of a VMDK file, samples of data are drawn from the file and examined by the machine learning model for encryption. When a sample is drawn, one or more modified blocks of data (i.e., blocks of modified data) of a given snapshot file are randomly selected and a byte frequency distribution of the sample is generated. A feature vector is configured based on the byte frequency distribution and supplied to a machine learning model which is trained to determine whether a sample of data is encrypted based on the byte frequency distribution of the sample.

In various implementations, a machine learning model is trained to differentiate encrypted portions or samples of data from non-encrypted samples based on a feature vector representation of a byte frequency distribution of the one or more blocks of data in the samples. For example, a 4k block of data from a snapshot of a VMDK file may be randomly sampled from the source data for analysis by the model. A byte frequency distribution of the data block is generated which indicates the relative frequency of the 256 possible byte values of the data block. A feature vector representation of the byte frequency distribution is generated which includes 256 elements corresponding to the 256 values in the distribution. The feature vector is supplied to the machine learning model, and the model returns a classification which indicates whether the block is encrypted or non-encrypted (i.e., normal). When the percentage of samples or blocks deemed by the model to be encrypted exceeds a threshold value, mitigative action can be taken to isolate the malware attack and prevent data loss. The threshold value may be based on a background level of encryption detected for the compute workload. The background level of encryption may be based on encryption levels of workloads of the virtual machine detected by the model during a learning period, i.e., during a period of normal operation.

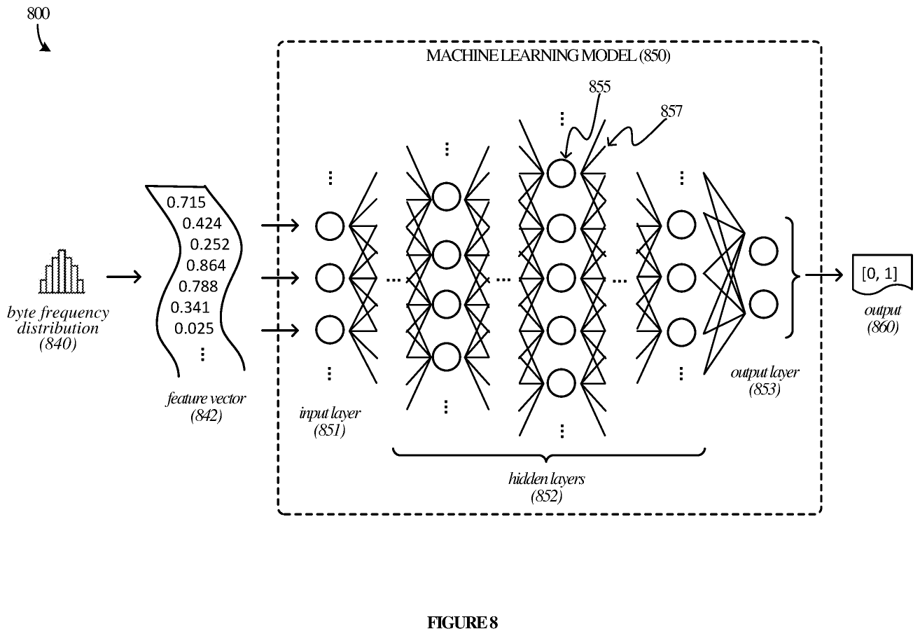

Machine learning models, such as those of the technology disclosed herein, are algorithms that learn patterns and relationships from data to make predictions on new, unseen data without deterministic programming. Machine learning models are trained on historical data, adjusting their parameters iteratively to improve performance on tasks such as classification to make predictions about the new data. Neural networks are a class of machine learning models including interconnected nodes organized into layers, with each layer processing and transforming input data to produce output. (An exemplary implementation of a machine learning model for encryption detection is depicted in FIG. 8 discussed infra.) Through a process of back propagation, neural networks learn by adjusting the strengths of connections between nodes to minimize the difference between predicted and actual outcomes. Neural networks are well-suited to tasks such as pattern recognition based on their ability to capture complex relationships in data.

In various implementations, to determine whether a VMDK file is maliciously encrypted, a representative sample of multiple modified blocks of data is randomly drawn from the VMDK file for evaluation by the trained machine learning model. For example, a set or grouping of three neighboring or co-located blocks of modified data may be randomly selected from the VMDK file and byte frequency distributions generated for each of the three blocks. The three distributions are then combined by concatenation, averaging, or splicing, and a feature vector is generated based on the combined distribution. When the feature vector for a given sample is submitted to the machine learning model, the model returns a classification based on patterns or characteristics of encryption detected by the model in accordance with its training. With each run of the model, a sample from the VMDK file is classified, and an aggregation of the sample classifications gives rise to a percentage of encrypted samples deemed encrypted. Subsequent to evaluating multiple samples from the VMDK file, if the percentage of encrypted samples exceeds a threshold value, then the system determines that the VMDK file is maliciously encrypted.

In some implementations, modifications made to a VMDK file may be monitored in real-time to detect malicious encryption. As blocks of data are written to the VMDK file (based on operations or processes occurring in the virtual machine), a representative sample of modified blocks may be selected for evaluation by the machine learning model. For example, the blocks may be selected at randomly determined intervals as they are written to the VMDK file. With a random sample of recently modified blocks selected, the machine learning model classifies the blocks as encrypted or non-encrypted based on the byte frequency distribution data of the blocks supplied to the model in feature vectors.

In an implementation, a machine learning model for determining a likelihood of malicious encryption is an artificial neural network trained on datasets which include 4k blocks of unencrypted data and encrypted data. The unencrypted datasets may include a variety of file types and sizes. To generate an encrypted dataset, unencrypted data may be encrypted using an encryption standard such as the 256-bit key AES (AES-256), RSA, or Data Encryption Standard (DES). The unencrypted and encrypted training datasets may include input or feature vectors based on a byte frequency histogram or distribution for the 4k data blocks along with ground-truth values or labels indicating whether the respective blocks are non-encrypted (normal) or encrypted. To make the machine learning model more robust, the training dataset may include zipped data (i.e., compressed data) along with unencrypted data to train the model to differentiate zipped data from encrypted data. The encrypted training datasets may also include variations in the manner of encryption, such as varying the percentages of encrypted data of an encrypted block, encryption of alternating bytes of data, encrypted headers, and so on.

Given a snapshot or back-up file of a compute workload, such as a compute workload of a virtual machine, the process of detecting malicious encryption begins with or includes a random sampling of data from the compute workload in an implementation. For example, where the workload data is organized into 4k data blocks, a specified number of co-located data blocks may be randomly selected for encryption screening, with the specified number of blocks corresponding to the size of the training datasets used to train the machine learning model. The sample size (e.g., number of blocks) on which the model is trained may be determined based on balancing processing speed with accuracy in predicting encryption and may vary according to characteristics of the workload data of a given virtual machine, particular where the characteristics are the result of confounding factors. For example, if the workload data typically includes a moderate level of non-malicious encryption activity, the model may be designed to receive a larger sample (i.e., more data blocks) to improve its accuracy (i.e., to reduce its rate of false positive errors). Similarly, if the workload data typically includes some amount of compressed data, the model may be designed to receive a larger sample because the characteristics of zipped or compressed data can be more difficult for the model to distinguish from encrypted data. In some cases, the threshold value for deeming a workload to be encrypted may be set to a higher value which accounts for a higher false positive rate where encryption detection is more challenging.

Various embodiments of the present technology provide for a wide range of technical effects, advantages, and/or improvements to computing systems and components. For example, various embodiments may include one or more of the following technical effects, advantages, and/or improvements: 1) unconventional and non-routine operations to systems for detecting ransomware infiltration; 2) dynamic integration of compute workload back-up technology and machine learning to identify encrypted or maliciously encrypted data in recently modified data; 3) automatically identifying malicious encryption of data to systems for data protection and ransomware attack mitigation; and/or 4) use of machine learning technology to increase the accuracy of and timeliness of malicious encryption of data. Some embodiments include additional technical effects, advantages, and/or improvements to computing systems and components.

Technical effects of the technology disclosed herein allow for reliable early detection of malicious encryption of data based on byte frequency distributions of portions of the data. To monitor a data source for early detection of malicious encryption, a system for encryption detection can be operated to continually monitor encryption levels of data samples to detect an increase in encryption activity which can be indicative of malicious encryption. Based on the accuracy of the machine learning model after training, encryption can be reliably detected from representative samples comprising a fraction of the source data as compared to entropy-based methods, resulting in faster detection and savings in processing costs. Moreover, the machine learning model reliably detects low levels of encryption in the samples. For example, when monitoring a compute workload of a VMDK file, detecting that 10% of the samples are encrypted may be sufficient to indicate malicious encryption. Thus, malicious encryption can be accurately detected even when it is not yet dominant in the source data.

Moreover, in addition to earlier detection, encryption detection based on byte frequency distribution is more accurate than entropy-based methods. Because entropy-based methods generally cannot distinguish entropy of compressed files from entropy of encrypted files, such methods are prone to a significantly higher rate of false positive signals as compared to detection based on byte frequency distribution in data sources which include compressed files. In contrast, with appropriate training, the technology disclosed herein can reliably distinguish compressed data from encrypted data based on patterns or characteristics of the byte frequency distributions, allowing the models to operate with greater sensitivity to lower levels of encryption and thus enabling earlier detection than entropy-based methods.

To improve accuracy in scenarios where the characteristics of the source data make encryption detection more challenging, the machine learning model can be scaled up and trained to receive larger samples of data for analysis. Moreover, a transformer-type machine learning model with compressed parameterization can reliably detect malicious encryption while reducing processing overhead as compared to other types of neural network models. Indeed, based on the smaller size and lower processing demands of transformer models, transformer models are well-suited for a multi-model deployment to accommodate a variety of workload data types and characteristics.

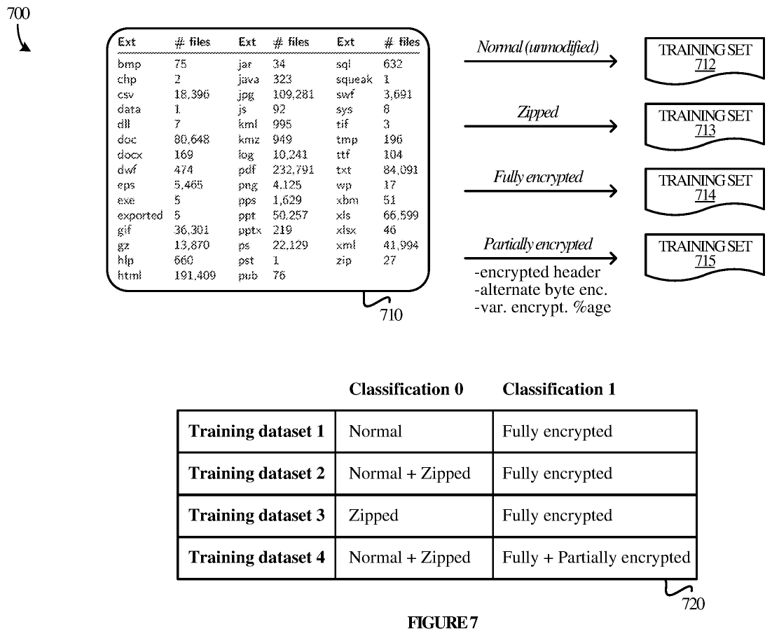

For a multi-model deployment, a set of differently trained models for signaling an encrypted workload may be deployed. By training multiple models on training data of varying levels of difficulty with respect detecting encryption, multiple models can provide varying levels of detection capability to accommodate a variety of data types or entropy characteristics of data, thus improving accuracy. In an implementation, once trained, the models may be deployed in a sequence according to increasing level of training difficulty and with threshold values for triggering evaluation by the next model in the sequence or, in the case of the last model in the sequence, for triggering mitigation. For example, the first model in a set of two models may be trained on a less challenging training data set (i.e., data according to classification is more distinctive) and deployed with a threshold of 10%, while the second model is trained on a more difficult training set and deployed with a threshold of 20%. If the first model detects that more than 10% of the samples are encrypted, then the samples are submitted to the second model. If the second model detects that more than 20% of the samples are encrypted, then mitigation is triggered. If, however, the second model detects that less than 20% of the samples are encrypted, then mitigation is not triggered and normal operation continues. The number of models in a multi-model deployment may vary; for example, as illustrated in FIG. 7 discussed infra, four training sets of varying levels of training difficulty are described which could be used to train four different models.

Because the methods disclosed herein do not rely on quantifying entropy to detect malicious encryption, more information is provided to the model on which to base the encryption classification. In other words, when entropy is computed for a dataset, a large quantity of data is distilled to a single value, so potentially useful information may be lost in the computation, such as patterns or behavior which may be characteristic of a ransomware infection. In contrast, generating an encryption classification based on high-dimension input vector derived from a byte frequency distribution of the data incorporates more information about the data than a single entropy value. As a result, the technology disclosed herein delivers a higher signal-to-noise ratio for classifying encrypted workloads and reduces the likelihood of false negative or false positive errors.

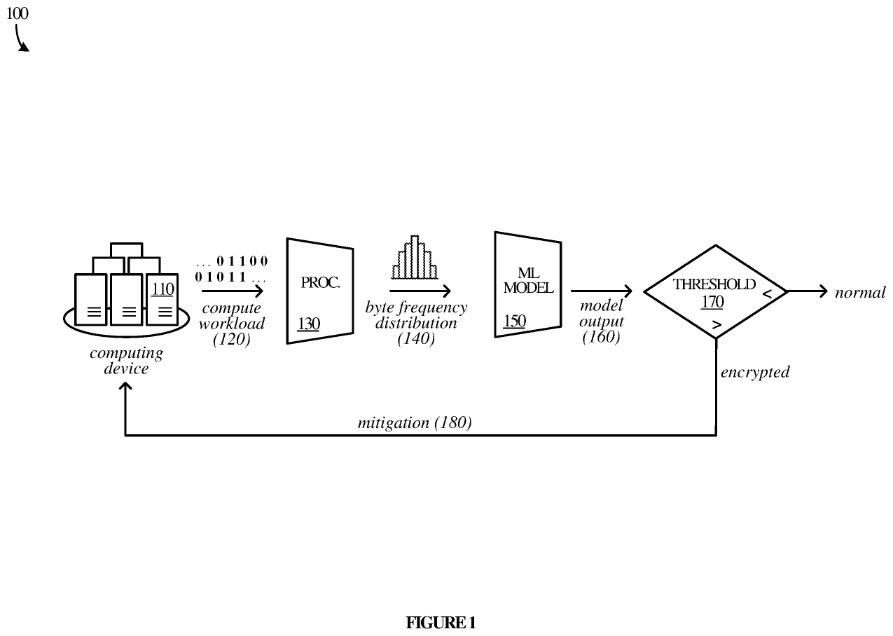

Turning now to the figures, FIG. 1 illustrates operational environment 100 for malicious encryption detection in an implementation. Operational environment 100 includes computing device 110, processor 130, machine learning model 150, and threshold function 170. In operational environment 100, compute workload 120 is transmitted by computing device 110 to processor 130. Byte frequency distribution 140 is transmitted from processor 130 to machine learning model 150, and machine learning model 150 generates and transmits model output 160 to threshold function 170 for evaluation. The elements of operational environment 100 may execute on one or more server computing devices, such as in a server computing environment for a system for data storage, management, and protection.

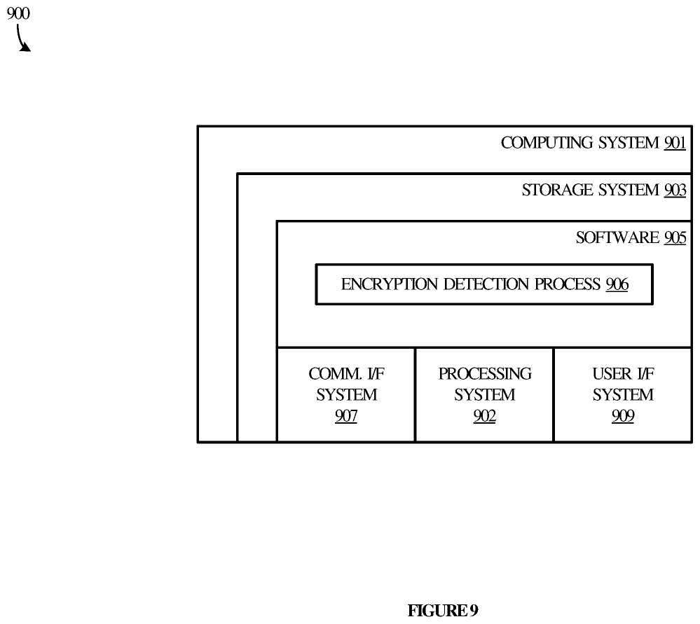

Computing device 110 is representative of a server or other computing device, of which computing system 901 in FIG. 9 is broadly representative. In various implementations, computing device 110 hosts a virtualized environment on a hypervisor platform for the operation of virtual machines (not shown) and dynamically allocates resources, such as processors, memory, and storage, to host multiple virtual machines on the hypervisor. Virtual machines executing on computing device 110, generated from VMDK files, encapsulate their own virtual computing devices which execute the virtual machine's processes and workloads, such as compute workload 120.

In accordance with the implementations illustrated in FIG. 1, compute workload 120 is representative of an instance or snapshot of a VMDK file of a virtual machine (not shown) executing on computing device 110. Compute workload 120 includes modifications to the VMDK file relative to a previous or baseline VMDK file. For example, compute workload 120 may include modified blocks of data that were written to the VMDK file since a previous VMDK snapshot was captured.

Processor 130 is representative of a computing function or operation which receives compute workload 120 and generates byte frequency distribution 140 of compute workload 120. In various implementations, processor 130 receives modified blocks of data of compute workload 120 and generates relative frequency distributions of byte values of the modified blocks, of which byte frequency distribution 140 is representative.

Machine learning model 150 is representative of an artificial neural network, such as a transformer model, which receives a feature vector including values from byte frequency distribution 140 of compute workload 120. Machine learning model 150 processes the input data in accordance with its training to generate model output 160. Model output 160 includes encrypted/non-encrypted classifications of data from which byte frequency distributions, such as byte frequency distribution 140, were derived. In various implementations, machine learning model 150 is trained using labeled datasets of non-encrypted and encrypted data. To generate model output 160, the output layer of machine learning model 150 may include an activation function which generates the resulting classification. In some implementations, the activation function maybe a softmax function that turns a vector of K real values into a vector of K real values that sum to 1. The input values can be positive, negative, zero, or greater than one, but the softmax transforms them into values between 0 and 1, so that they can be interpreted as probabilities.

Threshold function 170 is representative of a computing function or operation which classifies compute workload 120 as “normal” or “encrypted” on the basis of model output 160. Threshold function 170 receives model output 160 from machine learning model 150 and compares model output 160 to a threshold value to determine whether compute workload 120 is being subjected to a ransomware attack. In comparing model output 160 to the threshold value, threshold function 170 determines whether a sufficient number or percentage of samples drawn from the source data to infer that the source data is itself encrypted or encrypted beyond normal. The threshold value may be determined based on capturing historical data relating to normal, background encryption activity (e.g., over a period of normal, non-encrypted operation) to determine an amount of encryption in excess of the norm (e.g., an average level of encryption activity) or a normative range.

A brief operational scenario involving elements of operational environment 100 in an implementation follows. Processor 130 selects a random sample of modified blocks of data from compute workload 120. Processor 130 generates byte frequency distribution 140 for the sample based on the relative frequency of byte values in the blocks. Processor 130 configures a feature vector (not shown) which includes distribution values from byte frequency distribution 140 and submits the feature vector to machine learning model 150.

Machine learning model 150 processes the feature vector to produce a resulting classification of the underlying data (i.e., data from the sample of modified blocks drawn from compute workload 120). Machine learning model 150 outputs the classification in model output 160 to threshold function 170.

Threshold function 170 receives model output 160 including the classification of the sample drawn from compute workload 120. As threshold function 170 receives additional classifications for other samples drawn from compute workload 120, threshold function 170 computes a predicted level of encryption for compute workload 120. The predicted level of encryption is based on a percentage of the samples or of the modified blocks in the samples which are classified as encrypted by machine learning model 150. When the predicted encryption level for compute workload 120 is less than a threshold value of threshold function 170, threshold function 170 returns an indication that compute workload 120 is normal or that no malicious encryption has been detected, and the system embodied in operational environment 100 continues to monitor other compute workloads from computing device 110.

If, however, the predicted encryption level of compute workload 120 exceeds the threshold value, threshold function 170 transmits a signal 180 for initiating mitigative action to computing device 110 on the basis of compute workload 120 being maliciously encrypted (or on the basis that excessively high encryption levels were detected). Upon receiving the signal 180 for mitigative action, computing device 110 may take steps to confirm or verify a malicious infiltration, to isolate the malware infection, to preserve the most recent VMDK snapshots deemed normal, and so on.

For the sake of illustration, let us assume that one hundred random samples are drawn from compute workload 120, with each sample including three modified blocks, and that machine learning model 150 classifies 4% of the samples as encrypted. If the threshold value is 6%, then threshold function 170 returns an indication that compute workload 120 is normal and computing device 110 continues to function as normal. If, however, machine learning model 150 had classified 8% of the samples as encrypted, then, with a threshold value of 6%, threshold function 170 would return an indication that compute workload 120 is indeed encrypted and signal 180 would be sent to computing device 110 to take mitigative action.

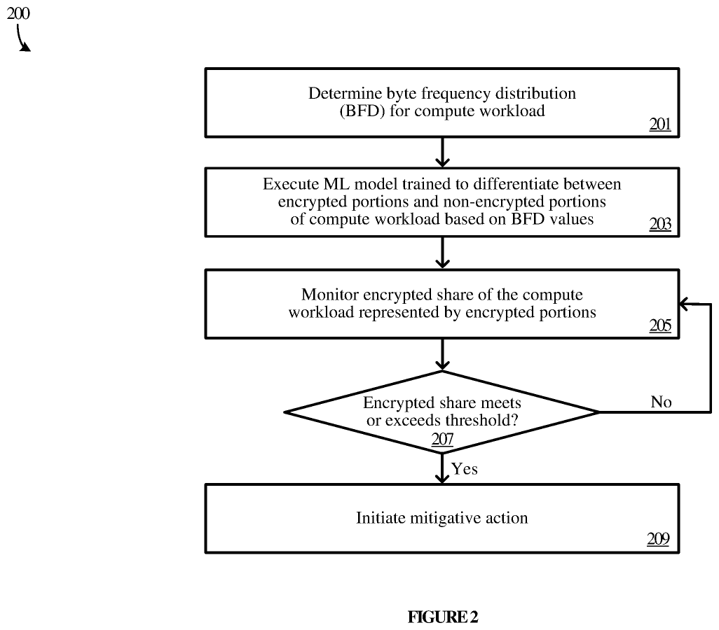

FIG. 2 illustrates a method for malicious encryption detection in an implementation, referred to herein as process 200. Process 200 may be implemented in program instructions in the context of any of the software applications, modules, components, or other such elements of one or more computing devices. The program instructions direct the computing device(s) to operate as follows, referred to in the singular for the sake of clarity.

In various scenarios, a computing device performs computing processes resulting in the generation of compute workloads. Instances of the compute workloads may be captured in image or snapshot files at periodic intervals for redundancy. Early detection of a ransomware attack is critical to thwarting such an attack, so the compute workloads may be examined for indications of malicious encryption, such as an atypical level of encryption of the workload data.

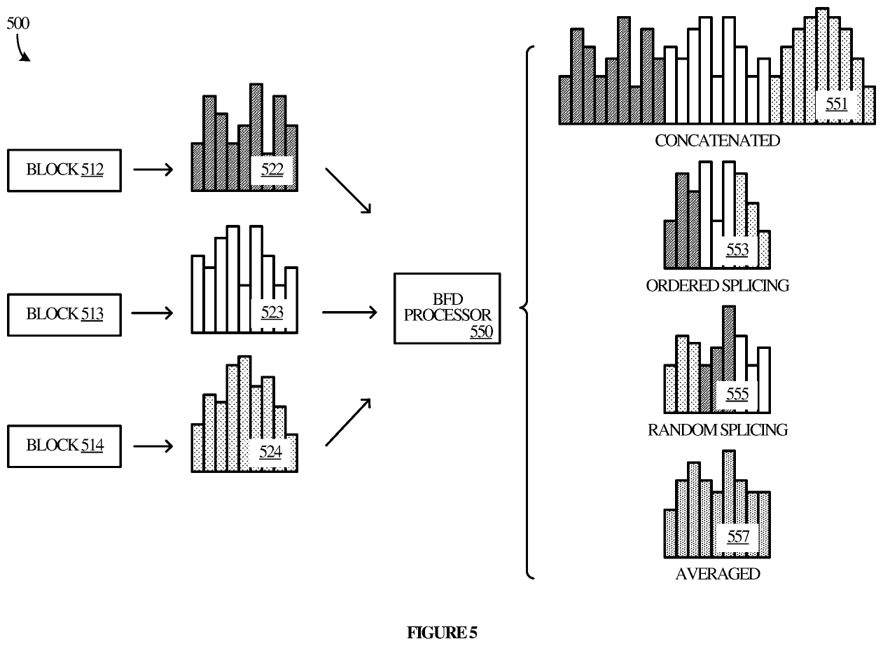

To detect a possible ransomware attack, the computing device determines a byte frequency distribution for a compute workload (step 201). In an implementation, compute workloads are captured in snapshots by the computing device, with each snapshot capturing recently modified data of the compute workload (i.e., data that has been modified since a previous snapshot or relative to a baseline workload file). As the snapshots are captured, to determine a recent or ongoing encryption level of the workload data, the computing device randomly samples a portion of recently modified data from a snapshot, for example, by randomly sampling one block of data or a grouping of multiple co-located or contiguous blocks of data which forms a single sample of data for testing. The computing device determines a byte frequency distribution for the selected block or blocks of data by tallying the frequency of byte values for each block and computing a relative frequency distribution for each block. For a sample of multiple blocks, the computing device combines the multiple byte frequency distributions of the blocks to form a single byte frequency distribution for the sample. (Methods of combining multiple byte frequency distributions to form a single byte frequency distribution for a sample are depicted in FIG. 5 discussed infra.)

The sample size selected for evaluation by the machine learning model may be determined based on balancing computational cost with accuracy. To wit, a larger sample (i.e., more kilobytes of data) may provide more information and thus greater accuracy but will be computationally more expensive than a smaller sample. Thus, the machine learning model may be tested with data samples of varying size to determine an optimal (minimum) sample size for a specified level of accuracy. Once a sample size is selected, the machine learning model may be trained for encryption detection based on the selected sample size; however, this will not necessarily change the design the model or its input layer in that the byte frequency distribution may be the same across multiple sample sizes.

Having generated a byte frequency distribution for the compute workload, the computing device executes a machine learning model to differentiate between encrypted portions and non-encrypted portions of the compute workload based on the byte frequency distribution values (step 203). In an implementation, the machine learning model is an artificial neural network which is trained to differentiate encrypted portions from non-encrypted portions of data based on byte frequency distribution values of the data (i.e., based on the relative frequency distribution of the byte values). To train the model, the model is fed labeled training data based on unencrypted, zipped, partially encrypted, and/or fully encrypted sets of data. (Methods for training the machine learning model are depicted in FIG. 7 discussed infra.) Based on its training, the model classifies a sample or portion of a compute workload as normal or encrypted based on the byte frequency distribution values of the portion.

In various implementations, the machine learning model is an artificial neural network, such as a transformer model, which receives a feature vector (i.e., a one-dimensional array of data) of the byte frequency distribution for a sample of data. For example, for a sample which includes a single block of data, the feature vector may be a 256×1 array of elements corresponding to the 256 values of the byte frequency distribution of the block data. Alternatively, where the sample includes, say, a grouping of three blocks of data, the feature vector may be a 256×1 array of elements corresponding to a byte frequency distribution created by combining the byte frequency distributions of the individual blocks. Alternatively, the feature vector for a sample of three blocks of data may be a 768×1 array of elements corresponding to a concatenation of the byte frequency distributions of the individual blocks.

The computing device monitors an encrypted share of the compute workload represented by the encrypted portions (step 205). In an implementation, snapshots of the compute workload are periodically captured and samples of data from the snapshots are selected for classification by the machine learning model. By continually evaluating samples of recently modified data from the snapshots, the computing device monitors an encrypted share of the compute workload on an ongoing basis. For example, the computing device may compute the encrypted share of the compute workload based on the percentage of samples deemed encrypted by the model: if 6% of the samples are deemed by the model to be encrypted, the computing device determines that the encrypted share of the compute workload is 6%. By continually monitoring the encrypted share of the workload over time, the computing device will be able to detect an increase in the portion of data which is encrypted which may indicate that a ransomware attack is underway.

The computing device initiates a mitigative action in response to the encrypted share meeting or exceeding a threshold (step 207). In an implementation, when the computing device determines, based on the output from the machine learning model, that the encrypted share of the compute workload has exceeded a threshold value, the computing device initiates action to verify the suspected attack, to isolate the infected data, and/or to preserve the data. For example, where the machine learning model has a historical average of 6% encryption error (that is, 6% of the samples are deemed encrypted when there is no malicious encryption) for a given virtual machine, the threshold may be set to a value greater than the historical average, such as 1.5 times the historical average or 9% to reduce false positive errors. When the computing device determines that the encrypted share of the compute workload has risen to 10% based on samples from the most recent snapshot, the computing device initiates mitigative actions, such as preserving the most recent snapshots which do not exhibit symptoms of infection. The computing device may also isolate the virtual machine by limiting interaction with the virtual machine by users or other computing devices and restrict access to the VMDK.

In an implementation, to determine a historical average for setting a threshold value, the machine learning model may be used to determine the historical average based on random sampling of compute workloads over a period of time or learning period during which the virtual machine is operating under typical conditions. For example, compute workloads may be captured at regular intervals over a period of several days or weeks of normal operation, with a number of samples drawn from each workload. In some cases, the learning period may be determined based on a known or native cycle of operations, such as a fiscal quarter. As the samples are fed to the machine learning model for classification, an encryption error can be determined based on false positive errors in the model's evaluation of the samples for malicious encryption. For example, the encryption error may be the percentage of classifications of non-encrypted test data which the model classifies as encrypted. Once a historical average is determined, the threshold value can be set to value which is higher than the encryption error (e.g., 1.5×, 2×) to reduce or eliminate false positive indications. While it may be preferable to capture a large sample of historical data to determine an encryption error, the learning period during which data is captured may be terminated once a pattern of behavior (i.e., encryption error) is established with consistency.

Referring again to FIG. 1, operational environment 100 illustrates process 200 in an implementation with reference to elements of operational environment 100. In operational environment 100, computing device 110 hosts one or more computing operations which generate compute workloads. For example, computing device 110 may execute a hypervisor which hosts a virtual machine based on a VMDK file, with snapshots of compute workload 120 capturing operational states of the virtual machine in the form of images of the VMDK file at different points in time. The system for detecting malicious encryption of data, including processor 130, machine learning model 150, and threshold function 170, monitors compute workloads, such as compute workload 120, which are generated by virtual machines or other processes executing on computing device 110. Processor 130, machine learning model 150, and threshold function 170 may execute onboard computing device 110 or on other computing apparatus in communication with computing device 110.

An implementation of process 200 in the context of FIG. 1 follows. Processor 130 determines byte frequency distribution 140 for compute workload 120. To determine byte frequency distribution 140, processor 130 receives a snapshot of compute workload 120 and draws a representative sample of recently modified data from the snapshot. The sample may include one or more modified blocks of data from the snapshot. Processor 130 generates byte frequency distribution 140 based on the relative frequency of byte values of the blocks in the sample.

Machine learning model 150 differentiates between encrypted portions and non-encrypted portions of compute workload 120. To differentiate between the encrypted and non-encrypted portions, machine learning model 150 receives input vectors from processor 130 which include values from byte frequency distributions from samples drawn from compute workload 120, such as byte frequency distribution 140 of the representative sample. Machine learning model 150 processes the input vectors to classify the samples as encrypted or non-encrypted.

Process 200 continues with monitoring the encrypted share of compute workload 120. To monitor the encrypted share of compute workload 120, threshold function 170 infers an encrypted share of compute workload 120 based on the percentage of samples deemed by the model to be encrypted. As samples are collected and classified, the encrypted share of compute workload 120 may vary based on variation in the activity of the virtual machine executing on computing device 110. To detect a malware attack, the encrypted share of compute workload 120 is compared to a threshold value which reflects an increased level of encryption over a nominal state of operation of the virtual machine. When the encrypted share meets or exceeds the threshold value, threshold function 170 signals computing device 110 to initiate mitigative action in response to detecting the elevated encryption level. Mitigative action includes steps taken to protect data onboard computing device 110 and to isolate the attack to prevent it from spreading to other devices in communication with computing device 110.

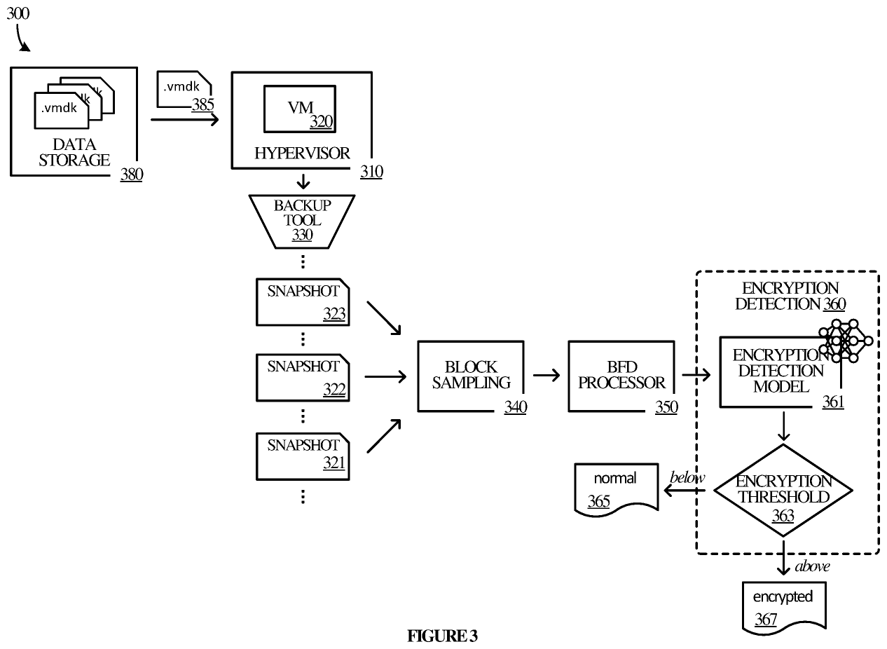

Turning now to FIG. 3, FIG. 3 illustrates operational scenario 300 for detecting malicious encryption of data in an implementation. Operational scenario 300 includes data storage 380, hypervisor 310 hosting virtual machine (VM) 320, backup tool 330, snapshots 321, 322, and 323, block sampling module 340, byte frequency distribution (BFD) processor 350, and encryption detection module 360 including encryption detection model 361 and encryption threshold function 363. In operational scenario 300, data storage 380 stores VMDK files by which virtual machines are created. For example, hypervisor 310 mounts VMDK file 385 from data storage 380 to host virtual machine 320 in a virtualized environment. As virtual machine 320 executes, backup tool 330 captures snapshots 321, 322, 323, and so on of compute workloads of virtual machine 320. Snapshots 321, 322, and 323 are representative of snapshots or image files of VMDK file 385 captured by backup tool 330. In an implementation, snapshots 321 include blocks of data of a compute workload of virtual machine 320, including blocks which were modified since that preceding workload snapshot was captured.

Block sampling module 340 is representative of a computing function or operation for collecting sample data from snapshots of VMDK file 385. For example, block sampling module 340 may randomly select, from among the modified blocks, one or more blocks from each of snapshots 321, 322, and 323. Thus, each sample includes recently modified data blocks (i.e., blocks that were modified since the preceding snapshot) so that detection can be focused on the most recent activity in virtual machine 320. In some scenarios, rather than samples being drawn randomly, samples may be drawn from a data source at regular intervals to ensure a distribution of samples across an operational cycle subject to the samples including modified data and being of adequate size (e.g., according to the size of the training data on which the model was trained).

Byte frequency distribution (BFD) processor 350 is representative of a computing function or operation for generating a byte frequency distribution for one or more blocks of data supplied by block sampling module 340. In an implementation, BFD processor 350 tallies the frequency of bytes in each data block according to byte value, then generates a distribution of the frequency data by value, that is, a byte frequency distribution. (A byte consists of eight bits each with a value of 0 or 1; thus, there are 28 or 256 possible values for a given byte.) For a highly simplified example of generating a byte value distribution, if a sample of data includes byte values (in decimal form) of 5, 7, 5, 8, 12, 5, 2, 0, 0, 1, an array of values for the byte frequency distribution would be [2, 1, 1, 0, 0, 3, 0, 1, 1, 0, 0, 0, 1, . . . ] and for a relative frequency distribution, [0.2, 0.1, 0.1, 0, 0, 0.3, 0, 0.1, 0.1, 0, 0, 0, 0.1, . . . ] based on dividing the byte frequencies by the total number of bytes in the sample (in this example, ten). In scenarios where the sample supplied by block sampling module 340 includes multiple blocks of data, BFD processor 350 creates a single byte frequency distribution representative of an entire sample by combining the distributions of the individual blocks, such as by averaging, splicing, or concatenation. Having generated a byte frequency distribution for a sample of data (from a single block of data or from multiple blocks), BFD processor 350 creates a feature vector for input to encryption detection model 361 based on values of the byte frequency distribution.

Encryption detection model 361 is representative of a machine learning model trained to differentiate encrypted samples of data from unencrypted samples of data based on a byte frequency distribution of the sample data. Encryption detection model 361 is trained to output a classification which indicates whether a sample of data from a workload is encrypted. As snapshots are captured and feature vectors are configured based on sample data from the snapshots, encryption detection module 360 continually monitors an encrypted share of the compute workload of virtual machine 320 by comparing the percentage of encrypted blocks detected by encryption detection model 361 to a threshold value of encryption threshold function 363.

As encryption detection model 361 classifies the samples from a snapshot of the compute workload, encryption threshold function 363 compares the percentage of encrypted blocks to a threshold value and returns either Normal indication 365 or Encrypted indication 367 with respect to corresponding snapshot. In an implementation, the threshold value of encryption threshold function 363 is determined based on historical data relating to encryption error or to background encryption activity during normal (non-malicious) use of virtual machine 320. For example, for a virtual machine which normally has little encryption activity, the threshold value may be set lower than for a virtual machine with frequent encryption activity. The threshold value may be periodically adjusted to reflect the changing nature of the compute workload or background encryption activity of a user or storage customer. The threshold value may be determined based on a learning period during which the model is deployed to learn the background level of encryption in a customer's environment. Upon capturing a representative sample of data to describe the background level of encryption under normal operation, the threshold value can be assigned, such as a percentage over (e.g., 1.5 times) the mean background encryption level for the learning period. In some scenarios, the threshold value may be based on the mean and standard deviation of the background encryption level, such as two times the standard deviation over the mean. In some scenarios, the threshold value may be based on the median background encryption level or other percentile of the background encryption level.

In an implementation, if/when the percentage of encrypted blocks detected or predicted by encryption detection model 361 exceeds the threshold value of encryption threshold function 363, the compute workload of virtual machine 320 is flagged as being encrypted, i.e., encrypt threshold function 363 returns an encrypted indication 367. Alternatively, if the predicted encryption level is below the threshold value, encryption threshold function 363 returns Normal indication 365 and the process of monitoring snapshots of the compute workload of virtual machine 320 continues.

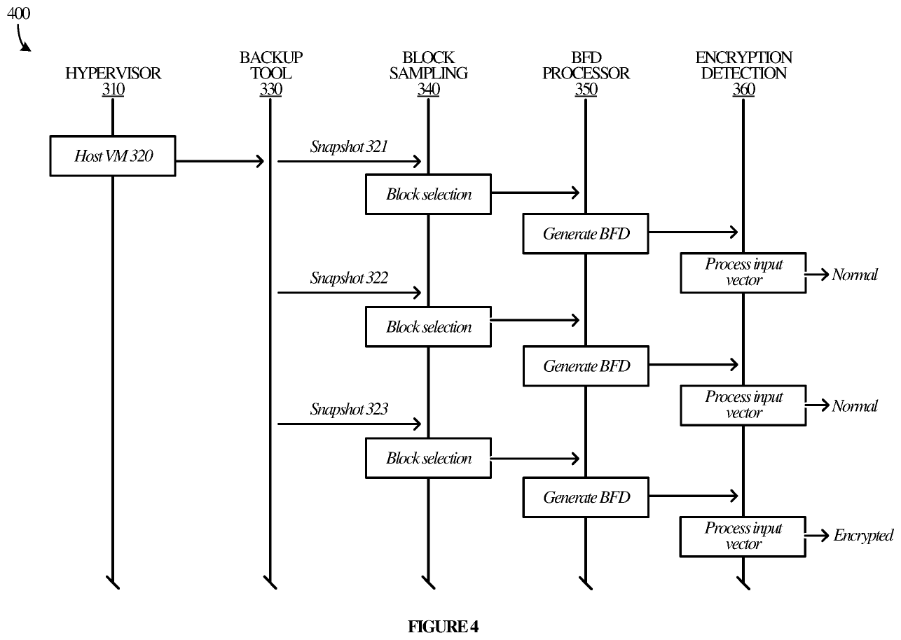

FIG. 4 illustrates workflow 400 for malicious encryption detection in an implementation, referring to elements of operational scenario 300. In workflow 400, hypervisor 310 hosts virtual machine 320 in a virtualized environment. As virtual machine 320 executes, backup tool 330 generates snapshots 321, 322, 323, and so on of the compute workload of virtual machine 320. Snapshots 321, 322, and 323 capture compute workloads of virtual machine 320 in the form of image files of the VMDK file 385 of virtual machine 320 at a moment in time.

When backup tool 330 captures snapshot 321, block sampling module 340 receives snapshot 321 and selects multiple samples of data from snapshot 321 for further processing. To select the samples of data, block sampling module 340 randomly selects one or more modified blocks of data from the data of snapshot 321. In selecting a sample which includes multiple blocks of data, block sampling module 340 identifies groupings of modified blocks (i.e., a set of modified blocks which are contiguous) in snapshot 321 and selects a grouping.

BFD processor 350 generates a feature vector for each sample produced by block sampling module 340 for submission to encryption detection model 361. To generate the feature vectors, BFD processor 350 generates a byte frequency distribution for each sample. Where the selected data of a sample includes multiple blocks, the byte frequency distribution may be created by concatenating, averaging, or splicing the byte frequency distributions of the individual blocks in the sample. BFD processor 350 submits the feature vector to encryption detection module 360 for processing.

Upon receiving a feature vector for a sample, encryption detection model 361 processes the vector data in accordance with its training and generates a classification indicating whether the sample data is encrypted. Encrypting threshold function 362 receives the classifications for the multiple samples from encryption detection model 361 and computes a predicted level of encryption of snapshot 321 based on the percentage of encrypted samples. Upon determining that the predicted level of encryption is below the threshold value, returns Normal indication 353.

Workflow 400 continues with backup tool 330 capturing snapshots 322 and 323 which are processed in a similar manner as snapshot 321. Encryption detection module 360 determines that the compute workload data of snapshot 322 has a normal level of encryption (i.e., below the threshold value), but that snapshot 323 has an elevated level of encryption. Upon detecting the elevated level of encryption, encryption threshold function 362 returns Encrypted indication 367, triggering mitigative action to protect the data of virtual machine 320 as well as other systems.

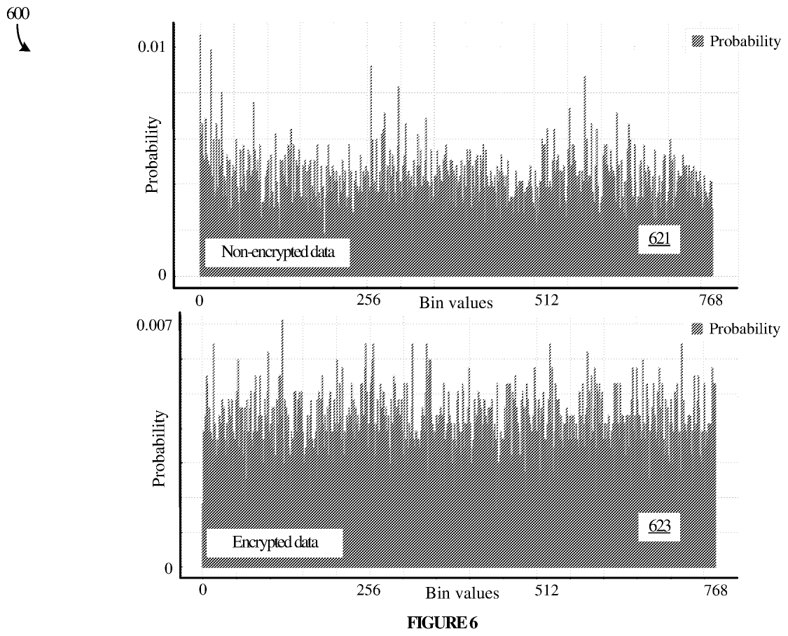

In FIG. 5, illustration 500 depicts methods of combining multiple byte frequency distributions into a single byte frequency distribution when sampling multiple blocks of data for detecting malicious encryption of the data in an implementation. In illustration 500, blocks 512, 513, and 514 are representative of 4k blocks of data which form a representative sample from a larger body of data, such as compute workload data file. In an implementation, a byte frequency distribution processor generates a byte frequency distribution for each block of data, as illustrated by distributions 522, 523, and 524. Each of distributions 522, 523, and 524 is a relative frequency distribution of byte values in the block of data, ranging from values of 0 to 255. As shown in illustration 500, BFD processor 550 combines distributions 522, 523, and 524 into a single distribution in one of a few different ways. For example, distributions 522, 523, and 524 may be concatenated to form distribution 551 according to the order of the blocks in the data file. (An example of forming a single byte frequency distribution by concatenating multiple distributions is also shown in FIG. 6.) Alternatively, portions of distributions 522, 523, and 524 may be spliced together to form distribution 553 which maintains the same dimensions as the individual distributions. Distribution 555 is generated in a similar manner as distribution 553 but the order of the blocks in the splicing is randomized. Distribution 557 is generated by BFD processor 550 by averaging the frequency values of the three distributions.

Tradeoffs in selecting a method of combining byte frequency distributions can include processing time and costs and accuracy in prediction. For example, concatenating several distributions presents more data for a trained machine learning model to work with, but at the expense of a larger machine learning model consuming more processing time and cycles. On the other hand, taking an average or other aggregation of the distributions will necessarily obscure some of the detail, pattern, or character of the distributions which may be apparent when viewing the distributions in their original form.

In FIG. 6, illustration 600 depicts byte frequency distributions for unencrypted and encrypted data in an implementation. Distribution 621 depicts a byte frequency distribution generated by concatenating the byte frequency distributions for three co-located blocks of unencrypted data from a PNG file, and distribution 623 depicts a byte frequency distribution generated in a similar manner but with the data encrypted. As shown, both distributions are noisy and largely indistinguishable to the eye, with no pattern or distinctive character to differentiate the encrypted data from the unencrypted data. However, when configured as a feature vector, a trained machine learning model can differentiate encrypted from unencrypted data based on the respective distributions.

Each of distributions 621 and 623 is formed by concatenating the byte frequency distributions of three co-located blocks of data (similar to distribution 551 of FIG. 5). Thus, each distribution includes 768 bars or classes of values representing the 256 possible values of each of the three data blocks. To configure the feature vector for distribution 621, for example, the values of each bar of the distribution is an element of 768-element feature vector. The feature vector is supplied to a machine learning model, such as machine learning model 150 of FIG. 1, which is designed to receive 768 input values. The model returns an output which indicates the level of encryption of the data based on the distribution data.

In FIG. 7, illustration 700 depicts methods of generating training data for training a machine learning model to differentiate encrypted and non-encrypted portions of data based on byte frequency distribution values in an implementation. In illustration 700, unencrypted dataset 710 includes a number of data files of different data types (e.g., .doc, .html, .pdf, and so on). The files may be processed in a number of different ways to generate training data. For example, in an unmodified state, dataset 710 forms training set 712. Compressing or zipping the contents of dataset 710 forms training set 713. Because zipped data can exhibit a higher level of noise or entropy, it can be more difficult to distinguish from encrypted data. Thus, including data from training set 713 when training the machine learning model will make the model more robust. Training sets 712 and 713 would be labeled as “normal” or “unencrypted” (classification 0) for training.

Next, dataset 710 may be encrypted by an encryption algorithm or standard, such as AES-256, to generate training set 714. Similarly, training set 715 is created by partially encrypting the data of dataset 710. For example, a randomly selected 50% of the data may be encrypted, or select portions of the data (e.g., headers or alternating bytes) may be encrypted. Training sets 714 and 715 would be labeled as “encrypted” (classification 1) for training.

Continuing with FIG. 7, training datasets may be configured by combining the training sets in different ways as illustrated in table 720. For example, in table 720, Training dataset 1 may be configured using training set 1 of “normal” data and training set 3 of fully encrypted data. These two sets may be the easiest or least robust given that the two types of data are the most distinguishable. In contrast with respect to difficulty, Training dataset 4 includes both normal and zipped data for the unencrypted portion of the training data and fully and partially encrypted data (e.g., 60% of the data is encrypted) for the encrypted portion of the training data. The training datasets may be balanced to include equal or nearly equal portions of data according to classification. The size of the portions may be selected according to the blocks of data to be classified at inference. For example, for classifying a compute workload of 4k blocks of data, the portions of the training data would also be sampled in 4k blocks.

To train the model, byte frequency distributions for portions of the training datasets are generated and corresponding feature vectors are created for the portions, with the elements of the vectors including the distribution values. Label data is included with each vector which indicates the classification (e.g., “0” or “1”). In some scenarios, feature vectors may be configured based on byte frequency distributions for individual blocks of training data or based on a combined byte frequency distribution for multiple blocks of training data.

The feature vectors are supplied to the model which generates a predicted classification. For each feature vector, the predicted classification is compared to the true classification, and a loss function is computed based on the differences between the predicted and true classifications. The loss function is then used to update the model parameters (e.g., weights and biases). Training continues until the model converges on a minimum value for the loss function, at which point the model is tested to evaluate its performance on fresh data. Upon achieving a satisfactory level of accuracy during testing, the model is deployed for inference.

The selection of training data may depend on a number of factors including the type of data which the machine learning model will examine and the types of workload operations which a user's or customer's virtual machine will be generating. For example, where a customer is working primarily with one type of data (e.g., image data, zipped data), a dataset (similar to dataset 710) may be configured from the customer's own (unencrypted) data and additional training data created by encrypting the data according to any of the methods depicted in illustration 700. In some scenarios, the machine learning model may be generally trained on datasets which include a variety of file types (such as those illustrated in dataset 710), then fine-tuned with additional training using customer data in unencrypted and encrypted form.

In an implementation of training, multiple models may be trained with each model on a particular type of training dataset, such as the training datasets as depicted in table 720. A model may be selected for inference based on having the lowest false positive rate during the testing phase of training. By selecting the model with the lowest false positive rate, the encryption threshold may also be set to a lower value (e.g., 1.5 times the false positive rate, 2.0 times the false positive, rate, etc.) which will enable greater sensitivity to malicious encryption and earlier detection of a ransomware attack.

In some implementations, multiple models may be trained and deployed to analyze compute workloads according to a sequence of increasingly robust evaluations with respect to encryption. For example, four models may be trained according to training sets 712-715, respectively. For each model, a threshold value is determined based on historical usage data or a learning period for a set of customer data or other data. When the model trained according to training set 712 detects that the percentage of encrypted samples exceeds its threshold, the samples are evaluated by the second model, i.e., the model trained according to training set 713. If the percentage of encrypted samples detected by the second model exceeds the threshold of the second model, then the samples are submitted to the third model, and so on. If any model in the sequence detects a percentage of encrypted samples that does not exceed its threshold, encryption is not flagged and mitigation is not triggered. Of course, implementations of a multi-model deployment may vary in the number of models and the types of training sets. For example, a three-model deployment may be based on training sets 712, 714, and 715. And in some scenarios, multiple models may be deployed to operate in parallel rather than in series, for example, for more rapid detection, although this may entail greater processing overhead.

FIG. 8 illustrates operational scenario 800 including a machine learning architecture for encryption detection in an implementation. Operational scenario 800 includes machine learning model 850, a conceptual representation of a neural network architecture for processing feature vectors, such as feature vector 842. Machine learning model 850 includes input layer 851, one or more hidden layers 852, and output layer 853. Each layer includes one or more nodes 855 interconnected by connections 857. Machine learning model 850 receives feature vector 842 based on values from byte frequency distribution 840. Upon processing feature vector 842, machine learning model 850 returns output 860 which includes a classification determined for byte frequency distribution 840.

In operational scenario 800, byte frequency distribution 840 includes a distribution of byte values generated from a sample of data based on tallying byte values from the data sample. For example, the distribution may include data classes ranging from values 0 to 255 or aggregated data classes with each class tallying and binning byte values for the bytes in a data sample. The tallies are then divided by the total number of data values to generate a distribution of the relative frequencies. For example, if the byte value “00111010” occurs 2860 times in a 4k sample, then the frequency of the class consisting of 00111010 is 2860 and the relative frequency for the class is 0.715. The values determined based on tallying the byte values from a data sample are the elements of feature vector 842 for input to a machine learning model, such as machine learning model 150 of FIG. 1.

Feature vector 842 is representative of a data structure for input to a machine learning model. In an implementation, feature vector 842 is a one-dimensional matrix or array of values from a byte frequency distribution or a relative frequency histogram of byte values. Each class of the distribution or histogram may include a single byte value or an aggregate of multiple byte values. For example, for a byte frequency distribution of 256 values (for byte values ranging from 0 to 255), feature vector 842 will include 256 elements or data values. Alternatively, the byte frequencies may be tallied according to classes comprising ranges or subsets of byte values, e.g., 0-50, 51-101, 102-152, 153-203, and 204-255. Similarly, for a concatenation of three distributions totaling 768 values, feature vector 842 will include 768 values. Feature vector 842 is input to trained machine learning model 850 to be classified as encrypted or non-encrypted in accordance with its training.

Continuing with FIG. 8, when feature vector 842 is input to machine learning model 850, the values are processed layer by layer according to the operations of nodes 855 which include parameters determined based on training. Each of the nodes of hidden layer 852 receives input values from nodes of the preceding layer and processes the input values according to parameters determined based on training, then outputs a value to the nodes of the next layer according to connections 857. The output values of output layer 853 are processed according to an activation function to generate output 860 which results in a classification comprising “non-encrypted” or “encrypted” for byte frequency data 840. In various implementations, output 860 includes a vector of values with each position indicative of a classification which the model was trained to detect. By normalizing the values output by the node to values between 0 and 1, the output values are ostensibly a probability which indicates the classification determined by the model based on its training. For example, the first position of the vector may be representative of a “normal” classification and the second position, an “encrypted” classification. Thus, as illustrated, the vector “[0, 1]” indicates an “encrypted” classification for byte frequency distribution 840.

In processing input values received from output layer 853, machine learning model 850 may implement an activation function which generates a value within a specified range. For example, the activation function may be a softmax function which returns values between 0 and 1 based on exponentiating and normalizing the inputs. The effect of exponentiating is to amplify differences between the input values to distinguish dominant values and suppress less significant ones. In some cases, the activation function for generating output 860 may be a ReLU (rectified linear unit) function which returns positive values of the K values and 0 for negative values or a sigmoid function which scales the K values into the range between 0 and 1.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements encryption detection process 906, which is (are) representative of the encryption detection processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including encryption detection process 906) may be implemented in program instructions and among other functions may, when executed by processing system 902, direct processing system 902 to operate as described with respect to the various operational scenarios, sequences, and processes illustrated herein. For example, software 905 may include program instructions for implementing an encryption detection process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support encryption detection in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
determine byte frequency distribution values associated with a compute workload;
execute a machine learning model trained to differentiate between encrypted portions and non-encrypted portions of the compute workload based on the byte frequency distribution values;
monitor an encrypted share of the compute workload represented by the encrypted portions; and
initiate a mitigative action in response to the encrypted share meeting or exceeding a threshold.

2. The computing apparatus of claim 1, wherein to determine the byte frequency distribution values associated with the compute workload, the program instructions further direct the computing apparatus to:
identify blocks of the compute workload; and
compute byte frequency distribution values for each of the identified blocks;
and wherein to monitor the encrypted share of the compute workload, the program instructions further direct the computing apparatus to:
execute the machine learning model to identify encrypted blocks of the identified blocks; and
compute the encrypted share based on a percentage of the encrypted blocks of the identified blocks.

3. The computing apparatus of claim 2, wherein to execute the machine learning model to identify the encrypted blocks of the identified blocks, the program instructions further direct the computing apparatus to:
encode the byte frequency distribution values for each of the identified blocks into feature vectors; and
supply the feature vectors as input to the machine learning model.

4. The computing apparatus of claim 3, wherein to encode the byte frequency distribution values into the feature vectors, the program instructions direct the computing apparatus to:
identify block groupings within the identified blocks, wherein each of the block groupings comprises three or more blocks; and
for each of the block groupings, encode the byte frequency distribution values determined for each of the three or more blocks into a single feature vector.

5. The computing apparatus of claim 4, wherein to encode the byte frequency distribution values determined for each of the three or more blocks into the single feature vector, the program instructions direct the computing apparatus to concatenate the byte frequency distribution values and to encode the concatenated byte frequency distribution values into each single one of the feature vectors.

6. The computing apparatus of claim 3, wherein the compute workload comprises a virtual machine disk file, and wherein the identified blocks of the compute workload comprise changed blocks of the virtual machine disk file.

7. The computing apparatus of claim 1, wherein the program instructions further direct the computing apparatus to:
identify an encryption error of the machine learning model with respect to the compute workload; and
set the threshold based on the encryption error.

8. The computing apparatus of claim 1, wherein the program instructions further direct the computing apparatus to train the machine learning model to differentiate between encrypted portions and non-encrypted portions of compute workloads based on byte frequency distribution values determined for portions of the compute workloads.

9. A method of operating a computing device comprising:
determining byte frequency distribution values for blocks of data of a compute workload;
executing a machine learning model trained to differentiate between encrypted blocks and non-encrypted blocks of the compute workload based on the byte frequency distribution values;
monitoring an encrypted share of the compute workload represented by the encrypted blocks; and
determining that the compute workload is encrypted based on the encrypted share of the compute workload.

10. The method of claim 9, wherein monitoring the encrypted share of the compute workload represented by the encrypted blocks further comprises computing the encrypted share based on a percentage of the encrypted blocks of the blocks of data drawn from the compute workload.

11. The method of claim 10, further comprising:
encoding the byte frequency distribution values into feature vectors; and
supplying the feature vectors as input to the machine learning model.

12. The method of claim 11, wherein encoding the byte frequency distribution values into feature vectors further comprises:
identifying block groupings within the blocks, wherein each of the block groupings comprises three or more blocks; and
for each of the block groupings, encoding the byte frequency distribution values determined for each of the three or more blocks into a single feature vector.

13. The method of claim 12, wherein encoding the byte frequency distribution values into feature vectors further comprises concatenating the byte frequency distribution values and encoding the concatenated byte frequency distribution values into each single one of the feature vectors.

14. The method of claim 9, wherein the compute workload comprises a virtual machine disk file, and wherein the blocks of data of the compute workload comprise changed blocks of the virtual machine disk file.

15. The method of claim 9, further comprising:
identifying an encryption error of the machine learning model with respect to the compute workload, wherein the encryption error is representative of an encryption level of the compute workload detected during normal operation; and
setting a threshold based on the encryption error, wherein determining that the compute workload is encrypted based on the encrypted share of the workload comprises determining that the encrypted share of the workload meets or exceeds the threshold.

16. One or more computer readable storage media having program instructions stored thereon that, when executed by one or more processors, direct a computing apparatus to at least:
determine byte frequency distribution values associated with a compute workload;
execute a machine learning model trained to differentiate between encrypted portions and non-encrypted portions of the compute workload based on the byte frequency distribution values;
monitor an encrypted share of the compute workload represented by the encrypted portions; and
initiate a mitigative action in response to the encrypted share meeting or exceeding a threshold.

17. The one or more computer readable storage media of claim 16, wherein to determine the byte frequency distribution values associated with the compute workload, the program instructions further direct the computing apparatus to:
identify blocks of the compute workload; and
compute a byte frequency distribution value for each of the identified blocks;
and wherein to monitor the encrypted share of the compute workload, the program instructions further direct the computing apparatus to:
execute the machine learning model to identify encrypted blocks of the identified blocks; and
compute the encrypted share based on a percentage of the encrypted blocks of the identified blocks.

18. The one or more computer readable storage media of claim 17, wherein the program instructions further direct the computing apparatus to:
encode the byte frequency distribution values into feature vectors; and
supply the feature vectors as input to the machine learning model.

19. The one or more computer readable storage media of claim 18, wherein to encode the byte frequency distributions into the feature vectors, the program instructions direct the computing apparatus to encode multiple byte frequency distribution values into each single one of the feature vectors.

20. The one or more computer readable storage media of claim 18, wherein the compute workload comprises a virtual machine disk file, and wherein the identified blocks of the compute workload comprise changed blocks of the virtual machine disk file.

21. A method of training an artificial neural network to differentiate between encrypted and non-encrypted data of a compute workload, the method comprising:
identifying non-encrypted data comprising a virtual machine disk file;
generating a training dataset comprising the non-encrypted data and encrypted data, wherein the encrypted data is generated by encrypting the non-encrypted data;
generating byte frequency distributions for portions of the non-encrypted data and portions of the encrypted data; and
training the artificial neural network based on values of the byte frequency distributions of the portions of the non-encrypted data and the encrypted data.

22. The method of training the artificial neural network of claim 21, further comprising:
for each portion of the portions of the non-encrypted data and the portions of the encrypted data, generating a feature vector based on the byte frequency distribution values of the respective portion.

23. The method of training the artificial neural network of claim 22, further comprising:
identifying a false positive error generated by the artificial neural network with respect to the training dataset; and
at inference, setting a threshold value for encryption detection based on the false positive error.

24. The method of training the artificial neural network of claim 22, wherein the non-encrypted training dataset includes compressed data.

25. The method of training the artificial neural network of claim 22, further comprising encrypting at least 50% of the non-encrypted data.

26. The method of training the artificial neural network of claim 22, further comprising encrypting the non-encrypted data using a 256-bit key Advanced Encryption Standard.
